(19) United States
(12) Patent Application Publication
(10) Pub. No.: US 2024/0412424 A1
(43) Pub. Date: Dec. 12, 2024

(54) Quantum Representation and Computation Method of Color

(71) Applicant: CHINA ACADEMY OF ART, Shangcheng District (CN)

(72) Inventor: Guosheng HU, Hangzhou (CN)

(21) Appl. No.: 18/212,522

(22) Filed: Jun. 21, 2023

(30) Foreign Application Priority Data
Jun. 21, 2022 (CN) 202210707570.9

(51) Int. Cl. G06T 11/00; G06N 10/20

(52) U.S. Cl. CPC G06T 11/001; G06N 10/20

(57) ABSTRACT

A quantum representation and computation method of a color is provided, including: step 1, converting a digital color into quantum bit (qubit) information according to channel values, which comprises converting element values of the digital color into a qubit superposition state representation; step 2, performing an editing operation by a quantum computing program, which comprises a computation method of editing a qubit state of the color through using a quantum operation gate; and step 3, restoring the digital color, which comprises converting a quantum editing result of the color into displayable color information, and applying the displayable color information to a qubit representation and editing of a color graphic image.

### CROSS REFERENCE TO RELATED APPLICATION

This patent application claims the benefit and priority of Chinese Patent Application No. 202210707570.9 filed with the China National Intellectual Property Administration on Jun. 21, 2022, the disclosure of which is incorporated by reference herein in its entirety as part of the present application.

### TECHNICAL FIELD

The present disclosure relates to the field of quantum computing of a color, and in particular, to a quantum representation and computation method of a color.

### BACKGROUND

In the field of quantum communication, research on quantum representation of color graphics have produced some outcomes, which mainly focus on quantum encryption for the purpose of information security and differ from an orientation concerned by general color computing. There is no effective method for applying quantum computing to the field of graphics.

On the basis of the current graphic display technology, a quantum bit (qubit) description and editing of a color still need to be based on single-color and RGB three-channel modes in classical computing, and it is desired to find a method for describing, editing, and restoring a color in combination with quantum computing and classical computing. Such a method should be capable of color computing by an operation way unique to a quantum computer, and a computing result can be extensively applied to a classical computer platform. An objective of some of embodiments of the present disclosure is to produce a result of evolution by using quantum states in a quantum mechanical system, perform quantum representation and computing on digital color information in classical computing, and then restore a quantum measurement result into color information in the classical computing. Along this path, the quantum computing of a color can be realized under the condition of collaboration of an existing quantum computer and a classical computer.

With the gradual promotion of quantum computing in scientific research and artistic creation, quantum representing and computing of a color will become a basis for color graphic processing and color computing.

### SUMMARY

An objective of some embodiments of the present disclosure is to provide a quantum representation and computation method of a color with respect to shortcomings in the prior ar.

To achieve the above objective, the present disclosure adopts the following technical solutions.

A quantum representation and computation method of a color, including:
step 1, converting a digital color into quantum bit (qubit) information according to channel values, which comprises converting element values of the digital color into a qubit superposition state representation;
step 2, performing an editing operation by a quantum computing program, which comprises a computation method of editing a qubit state of the color through using a quantum operation gate; and
step 3, restoring the digital color, which comprises converting a quantum editing result of the color into displayable color information, and applying the displayable color information to a qubit representation and editing of a color graphic image.

Further, representing a color parameter of a single channel by a qubit in step 1 comprises: mapping a color channel value ranging from 0 to 255 at each pixel into a value of an angle θ of a qubit Bloch sphere ranging from 0 to π:

$$\\ θ = acos ( 2 \frac{i}{max} - 1 ) ;$$

rotating θ to a corresponding angle by a quantum gate, performing further quantum operation computing, and setting a probability value α for a state |0> or β for a state |1> as a mapped value or a computing result for the channel;

where an Ry gate is utilized to set a bit state of the color parameter, which is a basic flow of quantum computing (FIG. 5); the quantum gate is operated to perform edition by rotating a point represented by a position on the Bloch sphere about a coordinate axis of the Bloch sphere to change the qubit superposition state; when the color parameter is represented by a qubit, a color element is converted into a corresponding angle θ, and a default initial superposition state |0> is rotated by θ about a Y-axis and an X-axis through using an R gate, thereby obtaining a quantum representation value of the color; the quantum superposition state is measured along a z-axis to obtain the probability value α which reflects an essential feature of the color; and if the color needs to be edited, after it is indicated that the channel value is converted to the Ry gate, a quantum state is edited under a control of the quantum gate until a measurement result is obtained.

Further, a relationship between qubit states corresponding to three channels of the color in step 1 and probabilities may be represented as:

$$\\ \vert ψ >= {P}_{1} \vert {R}_{0} {G}_{0} {B}_{0} > + {P}_{2} \vert {R}_{0} {G}_{0} {B}_{1} > + {P}_{3} \vert {R}_{0} {G}_{1} {B}_{0} > + {P}_{4} \vert {R}_{0} {G}_{1} {B}_{1} > + {P}_{5} \vert {R}_{1} {G}_{0} {B}_{0} > + {P}_{6} \vert {R}_{1} {G}_{0} {B}_{1} > + {P}_{7} \vert {R}_{1} {G}_{1} {B}_{0} > + {P}_{8} \vert {R}_{1} {G}_{1} {B}_{1} > ;$$

where probabilities of states meet:

$$\\ {P}_{1}^{{}_{} 2} + {P}_{2}^{{}_{} 2} > + {P}_{3}^{{}_{} 2} > + {P}_{4}^{{}_{} 2} > + {P}_{5}^{{}_{} 2} > + {P}_{6}^{{}_{} 2} > + {P}_{7}^{{}_{} 2} > + {P}_{8}^{{}_{} 2} = 1 ;$$

that is, an overall sum of probabilities that a value of red (R) channel is 0 based on a corresponding measurement result term thereof is:

$$\\ R = {P}_{1} + {P}_{2} + {P}_{3} + {P}_{4} ;$$

therefore, when measured by a color editing program resulting from superposition of three qubits, a sum of probabilities that a qubit corresponding to each channel is in a state |0> is regarded as a measured value for the channel; and a sum of P values for each channel is: R=P_{|000>}+P_{|001>}+P_{|010>}+P_{|011>} (a sum of probabilities that a qubit corresponding to the R channel is in the state |0>); G=P_{|000>}+P_{|100>}+P_{|001>}+P_{|101>} (a sum of probabilities that a qubit corresponding to a G channel is in the state |0>); and B=P_{|000>}+P_{|110>}+P_{|100>}+P_{|010>} (a sum of probabilities that a qubit corresponding to a B channel is in the state |0>).

Further, for a bit representation of a color relationship representation between a plurality of colors in step 1, the plurality of colors need to meet following condition:

$$\\ \{ {R}_{1} , {G}_{1} , {B}_{1} \} \neq \{ {R}_{2} , {G}_{2} , {B}_{2} \} \neq ... \neq \{ {R}_{n} , {G}_{n} , {B}_{n} \} ,$$

according to the condition, on the Bloch sphere, positions each representing ψ of a color do not overlap; and

for description of a constitution relationship of two colors, a spatial relationship of the two colors on the Bloch sphere is described by a Euclidean metric formula:

$$\\ ρ = \sqrt{} ( {( {R}_{1} - {R}_{2} )}^{2} + {( {G}_{1} - {G}_{2} )}^{2} + {( {B}_{1} - {B}_{2} )}^{2} ) .$$

With the technical solutions of the present disclosure, the present disclosure has the following beneficial effects: the present disclosure provides an editing method for realizing quantum representing and computing of a color. The method allows for representation of a digital color channel framework in a traditional computing technique by a qubit and editing of a channel combination relationship of colors by qubit superposition.

### BRIEF DESCRIPTION OF THE DRAWINGS

FIG. 1 illustrates a typical quantum computing program for a color;

FIG. 2 illustrates a program of symmetrical restorability of a quantum gate operation;

FIG. 3 illustrates a quantum image processing program for entanglement editing among color channels of an image in different color modes;

FIG. 4 are pictures illustrating an effect of realizing quantum color editing on a single image based on a quantum computing program of FIG. 3; and

FIG. 5 illustrates a basic flow of quantum computing.

### DETAILED DESCRIPTION OF THE EMBODIMENTS

Specific embodiments of specific solutions of the present disclosure are further described below with reference to the accompanying drawings.

A quantum representation and computation method of a color includes the following steps 1-3.

In step 1, a digital color is converted into qubit information according to channel values, which includes converting element values of the digital color into a qubit superposition state representation.

In step 2, an editing operation is performed by a quantum computing program, which includes a computation method of editing a qubit state of the color through using a quantum operation gate.

In step 3, the digital color is restored, which includes converting a quantum editing result of the color into displayable color information, and applying the displayable color information to a qubit representation and editing of a color graphic image.

Specifically, a quantum superposition state representation of a color element is as follows.

Based on the basic principle of quantum computing, a state of a qubit is represented as: |ψ>=α|0>+β|1>, where α²+β²=1. On a Bloch sphere, such a quantum state is represented as a triangular relationship with a Bloch diameter as a hypotenuse and a vertex at which a vertex angle θ is formed within 0 to π. In conversion of |0> and |1>, probability changes of two states can better reflect the influence of an external factor, and thus a determining factor is probabilities of being in two states. The key of representing color channel information by a qubit is to establish a mapping relationship between the color channel information and probability values of states |0> and |1> obtained by quantum measurement.

A method for representing a single-channel color by a qubit is as follows.

For a single-channel color (e.g., a black-and-white image), each pixel has only one channel value. If a color channel value is represented by a qubit, a color channel value ranging from 0 to 255 at each pixel is mapped into a value of an angle θ of a qubit Bloch sphere ranging from 0 to π:

$$\\ θ = acos ( 2 \frac{C}{255} - 1 ) .$$

Then, θ is rotated to a corresponding angle by a quantum gate, and further quantum operation computing is performed, and finally a probability value α or β (the value α is chosen as a mapping target) of state |0> or |1> is set as a mapped value or a computing result for the channel.

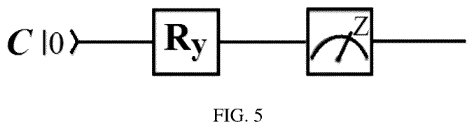

Conversely, by quantum measurement along the z-axis, the value α in the result may be restored into the color channel value. The basic quantum computing flow of the method is as shown in FIG. 5.

A quantum gate operation may be understood as an editing by rotating a point represented by a position on the Bloch sphere about a coordinate axis of the Bloch sphere to change the qubit superposition state. When a color parameter is represented by a qubit, a color element should be converted into a corresponding angle θ, and a default initial superposition state |0> is rotated by θ about a Y-axis and an X-axis through using an R gate, thereby obtaining a quantum representation value of the color. The quantum superposition state is measured along a z-axis to obtain a probability value α which reflects an essential feature of the color. If the color needs to be edited, after it is indicated that the channel value is converted to the Ry gate, the quantum state is edited under the control of the quantum gate until a measurement result is obtained.

A method for representing a single color by three qubits is as follows.

Taking the RGB color mode for example, the Z, X, and Y axes on the Bloch sphere may correspond to the R, G, and B channels of the color (this may also be applied to color modes such as HSI, xyz, and lab). Three color channels are respectively represented as:

$$\\ Z : {R}_{0} \vert 0 > , {R}_{1} \vert 1 > ; ( R channel )$$

$$\\ X : {G}_{0} ( \vert 0 > - \vert 1 > ) / \sqrt{} 2 , {G}_{1} ( \vert 0 > + \vert 1 > ) / \sqrt{} 2 ; ( G channel )$$

$$\\ Y : {B}_{0} ( \vert 0 > - i \vert 1 > ) / \sqrt{} 2 , {B}_{1} ( \vert 0 > + i \vert 1 > ) / \sqrt{} 2 ; ( B channel )$$

or represented as:

$$\\ R ( Z ) : \vert 0 > , \vert 1 > ; G ( X ) : \vert -> , \vert + > ; B ( Y ) : \vert - i > , \vert + i > .$$

A value ψ of the qubit representing each channel is represented by a trigonometric function, and dimension values corresponding to the R, G, and B color channels of each pixel constitute the position of the color on the Bloch sphere, which may be described as:

$$\\ \vert ψ {>}_{C} = ( x , y , z ) = ( cos φ sin θ , sin φ sin θ , cos θ ) .$$

In addition, the R, G, and B channels of a color each correspond to one qubit, and intensity values of the three channels are obtained by counting probabilities in quantum observation results. For each channel, if the observed value 0 of the corresponding qubit is set as an effective value of the channel, a sum of a probabilities P that the channel exhibits |0> when in the superposition state with other channels is the intensity of the channel. By this method, a relationship between the qubit states corresponding to the R, G, and B channels of a color and probabilities may be represented as:

$$\\ \vert ψ > = {P}_{1} \vert {R}_{0} {G}_{0} {B}_{0} > + {P}_{2} \vert {R}_{0} {G}_{0} {B}_{1} > + {P}_{3} \vert {R}_{0} {G}_{1} {B}_{0} > + {P}_{4} \vert {R}_{0} {G}_{1} {B}_{1} > + {P}_{5} \vert {R}_{1} {G}_{0} {B}_{0} > + {P}_{6} \vert {R}_{1} {G}_{0} {B}_{1} > + {P}_{7} \vert {R}_{1} {G}_{1} {B}_{0} > + {P}_{8} \vert {R}_{1} {G}_{1} {B}_{1} > ;$$

where probabilities of states meet:

$$\\ {P}_{1}^{{}_{} 2} + {P}_{2}^{{}_{} 2} > + {P}_{3}^{{}_{} 2} > + {P}_{4}^{{}_{} 2} > + {P}_{5}^{{}_{} 2} > + {P}_{6}^{{}_{} 2} > + {P}_{7}^{{}_{} 2} > + {P}_{8}^{{}_{} 2} = 1.$$

That is, a value of a red (R) channel is based on an overall sum of probabilities that corresponding measurement result term thereof is 0:

$$\\ R = {P}_{1} + {P}_{2} + {P}_{3} + {P}_{4} .$$

Therefore, when measured by a color editing program resulting from superposition of three qubits, a sum of probabilities that the qubit corresponding to each channel is in the state |0> is regarded as a measured value for the channel. A sum of P values for each channel is: R=P_{|000}>+P_{|001>}+P_{|010>}+P_{|011>} (a sum of probabilities that the qubit corresponding to the R channel is in the state |0>); G=P_{|000>}+P_{|100>}+P_{|001>}+P_{|101>} (a sum of probabilities that the qubit corresponding to G channel is in the state |0>); and B=P_{|000>}+P_{|110>}+P_{|100>}+P_{|010>} (a sum of probabilities that the qubit corresponding to B channel is in the state |0>). That is, each color is represented by three qubits, and a three-qubit superposition unit with each color channel being represented by one qubit is formed, i.e., |RGB> (this may also be applied to color modes such as HSI, xyz, and lab).

When a color object is observed, the color of the object is described by hue, saturation and intensity. A hue-saturation-intensity (lightness) (HSI or HSL) color model uses three parameters H, S, and I to describe color characteristics, where H defines the frequency of a color, called hue; S represents how subtle or intense the color is, called saturation; and I represents intensity or lightness. In a double-hexagonal pyramid representation of the HSI color model, I is an intensity axis, and a range of angles of hue H is [0, 2π], where the angle of pure red is 0, the angle of pure green is 2π/3 and the angle of pure blue is 4π/3.

A Lab color model is composed of three elements: luminosity (L), and a and b related to colors. L represents luminosity, which is equivalent to lightness; a represents a range from red to green; and b represents a range from blue to yellow. A value of L ranges from 0 to 100. When L=50, it is equivalent to 50% of black; a value of a or b ranges from +120 to −120, where +120a represents red, and −120a represents green. Similarly, +120b represents yellow, and −120b represents blue. The three values change alternatively to derive all colors.

A color relationship among multiple colors is represented as follows.

The so-called multiple colors refer to two or more different colors being present in an image, which are mainly reflected in differences of color element parameters. Taking the RGB color mode for example, two different colors are derived as long as the color of any of the three channels varies. Therefore, a plurality of colors must meet the following condition:

$$\\ \{ {R}_{1} , {G}_{1} , {B}_{1} \} \neq \{ {R}_{2} , {G}_{2} , {B}_{2} \} \neq … \neq \{ {R}_{n} , {G}_{n} , {B}_{n} \} .$$

That is, on the Bloch sphere, positions each representing ψ of a color do not overlap. Moreover, the larger a relative distance between colors is, the greater the color contrast is. When a distance between two colors is the largest (the line connecting two points passes through the center of the sphere), the color contrast is the greatest. The color relationship represented as a quantum state difference is of great significance in quantum computing. Many quantum operations may change computing results directly according to a differentiating feature of two or more quanta or a fixed condition. Differences between colors provide many prerequisite conditions for quantum operations.

The color relationship of a combination of a plurality of colors is actually a similarity and difference problem of color elements. Therefore, an overall feature of a set of colors may be described by describing a distribution (or a difference of ψ) of the colors on the Bloch sphere. This may provide a new method for measuring a sensate feature and a color relationship of a combination of colors. That is, a contrast relationship and similar attributes among colors may be handled by controlling an angular relationship of qubits of color channels on the Bloch sphere. A spatial relationship of such a color relationship on the Bloch sphere may be described by a Euclidean metric formula:

$$\\ ρ = \sqrt{} ( {( {R}_{1} - {R}_{2} )}^{2} + {( {G}_{1} - {G}_{2} )}^{2} + {( {B}_{1} - {B}_{2} )}^{2} ) .$$

A method for representing an image structure and a pixel position by qubits is as follows.

A graphic image is composed of pixels or vector regions of different colors. An image may be understood as a set of color points with particular coordinates, where each color may be described as (x, y:RGB), i.e., coordinates and color parameters. When the color information of a pixel is represented by qubits, the color parameters and the pixel coordinates may be represented as:

$$\\ \vert {RGB}_{} > ⊗ \vert {xy}_{} > .$$

According to the present disclosure, the probability values for two states 0 and 1 in a qubit measurement result are used to represent coordinate parameters. Thus, two qubits may be sufficient to represent the pixel information of a two-dimensional image (only three qubits are needed in a three-dimensional space, and so on). That is, in the measurement result of |xy>, the following state is present:

$$\\ \vert ψ > = {P}_{1} \vert {x}_{0} {y}_{0} > + {P}_{2} \vert {x}_{0} {y}_{1} > + {P}_{3} \vert {x}_{1} {y}_{0} > + {P}_{4} \vert {x}_{1} {y}_{1} > ,$$

where

$$\\ {P}_{1}^{{}_{} 2} + {P}_{2}^{{}_{} 2} > + {P}_{3}^{{}_{} 2} > + {P}_{4}^{{}_{} 2} > = 1.$$

With a probability when a measured value is 0 as a condition for representing a coordinate value, a coordinate value of a pixel corresponds to a sum of probabilities that the measurement result term is 0:

$$\\ x = {P}_{1} + {P}_{2} ;$$

and

$$\\ y = {P}_{3} + {P}_{4} .$$

Then, the sum of probabilities is mapped into the pixel coordinates to restore the position of each pixel in the image. Such a method may be unstable under the influence of quantum spin noise. However, the noise may be reduced to a reasonable level by increasing the number of measurements.

Another method is to record pixels in an image in a sequence and represent each pixel by a qubit (|RGBi>, i being a pixel index), and then locate the position of the pixel in the sequence according to the probability that the measured resulting state is 0. Such a method needs to mark a size of the image and calculate the angle of ψ according to a maximum of the pixel sequence of the image and the index of the current pixel:

$$\\ θ = acos ( 2 \frac{i}{max} - 1 )$$

where max is a total number of pixels of the image.

The computing of editing a qubit state of a color by using a quantum operation program is as follows.

The basic composition of a quantum computing program for editing and computing color parameters is as follows.

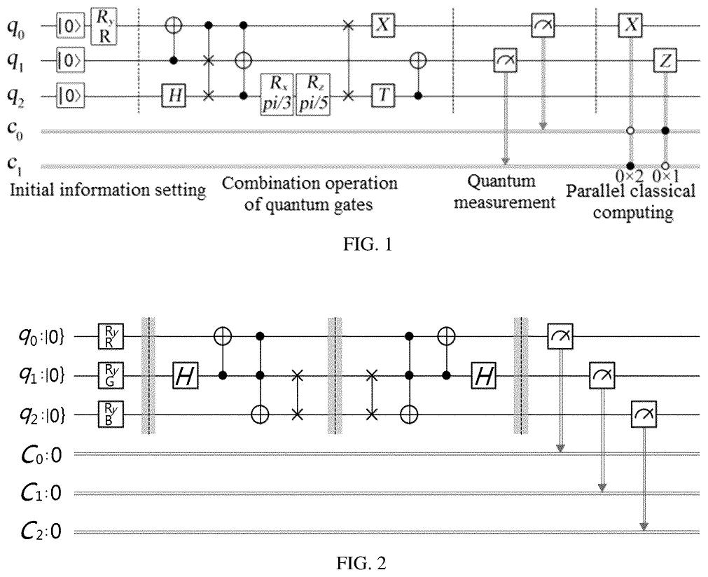

A quantum editing program for a color is a program link having a quantum computing function based on a combination of quantum gates, and generally includes four parts: creation of qubits of color channel parameters, combination of quantum gates, measurement of qubit state, and parallel classical computing of color restoration, as shown in FIG. 1.

The creation of qubits of a color includes creating a certain number of qubits and initially setting each qubit state to represent color channel values. The creation of qubits actually refers to setting a computing condition and a resource space in the software and hardware environment of quantum computing, and initial quantum setting determines the scale and computing power of the whole quantum program.

The combination of quantum gates determines the logical structure of the computing program, which is mainly characterized by: representing information for computing through using particular quantum gate parameters and then performing combination operation of various quantum gate tools to complete the qubit editing of color elements. This step is the core of quantum computing of a color.

Quantum measurement is a step of obtaining a result from the combination operation of quantum gates. The qubit after the combination operation of quantum gates is still in the spin state, and spin can be ended only after the quantum measurement is performed, to obtain a computing result. A measurement phase is a phase at which a quantum computing result is obtained, and also a phase at which the qubit state is transformed into a classical bit. After being measured, the quantum information may enter a classical computing and application phase.

Since the quantum computing result of the color finally needs to go back to the application scenario of the classical computing environment, the parallel classical computing part is the basis of existing quantum computing of a color. Moreover, many quantum computing programs for a color are executed synchronously with classical computing, and some quantum operations also need to be performed synchronously with external classical computing condition interfaces. By these external classical computing condition interfaces, the possibility that the whole color computing program experiences variable interaction with external information may be improved.

The quantum editing and measurement results of the color parameters are restored into the digital color as follows.

A general flow of quantum editing of color graphics includes firstly representing color channel information by qubits, then performing an entanglement operation among these qubits, and finally reconstructing the overall effect of image colors by means of a contrast relationship among channels. However, the basis of many experiments is external data rather than the color parameters. Therefore, these data must be transformed into the qubit information, and then a color relationship scheme is formed according to the structural relationship of the data to realize color visualization. Variables for editing image colors may be from data, particular color information, the information of another image, or the like, or may be from a function and an expression. The following shows the core part of the quantum computing program, where the color channel information of three images are represented by 9 qubits, and entanglement among colors is established. The program is combined with external variables to affect an entanglement relationship of channels and a result measurement output process.
q=QuantumRegister(9, ‘q’)
c=ClassicalRegister(3, ‘c’)
qc=QuantumCircuit(q, c)

# Initial values of the qubits are set by rotating the RGB channel values of two images about the Y-axis of the Bloch sphere.
qc.ry(img1[k][0], q[0])
qc.ry(img1[k][1], q[1])
qc.ry(img1[k][2], q[2])
qc.ry(img2[k][0], q[3])
qc.ry(img2[k][1], q[4])
qc.ry(img2[k][2], q[5])
qc.ry(img3[k][0], q[6])
qc.ry(img3[k][1], q[7])
qc.ry(img3[k][2], q[8])

# Editing by a controlled-X gate among the channels is as follows:
qc.ccx(q[0], q[3], q[6])
qc.ccx(q[1], q[4], q[7])
qc.ccx(q[2], q[5], q[8])

# Qubit measurements of the computing results are as follows:
qc.measure(q[6], c[0])
qc.measure(q[7], c[1])
qc.measure(q[8], c[2])

# Computing is performed on an IBM Q simulator (this part may be performed by selecting a different qutanum computer).
simulator=Aer.get_backend(‘qasm_simulator’)
result=execute(qc, simulator, shots=shotsNum).result( )
count=result.get_counts(qc)

In a quantum computing program, when the combined quantum gate operations are distributed symmetrically, the computed object will be restored. Here, taking an image for example, in consideration of various pixels with different color parameters in the image, if the invertibility of the computing result is stable enough, a result similar to the original image should be obtained after the symmetrical quantum gate operations. The symmetrical operations can restore the essential feature of the image and have quite high stability. FIG. 2 illustrates a program that the color is restored by using the symmetrical operations in a quantum computing case.

A qubit representing and editing method for a color graphic image is as follows.

The qubit editing operation for graphic color elements of the image is as follows.

In the quantum computing program for a color, control gates such as CNOT, CCNOT, and CSWAP that reflect the quantum entanglement state may be combined to construct a mutual relationship and linkage of the color channel information. There may be the following two forms according to a linkage relationship: a mutual control among different channels of a single color or a pixel is utilized to realize quantum editing and form a new color relationship and visual effect; and a mutual control of the channel information among different colors or different images is utilized to form a cross-correlation among multiple images and multiple colors.

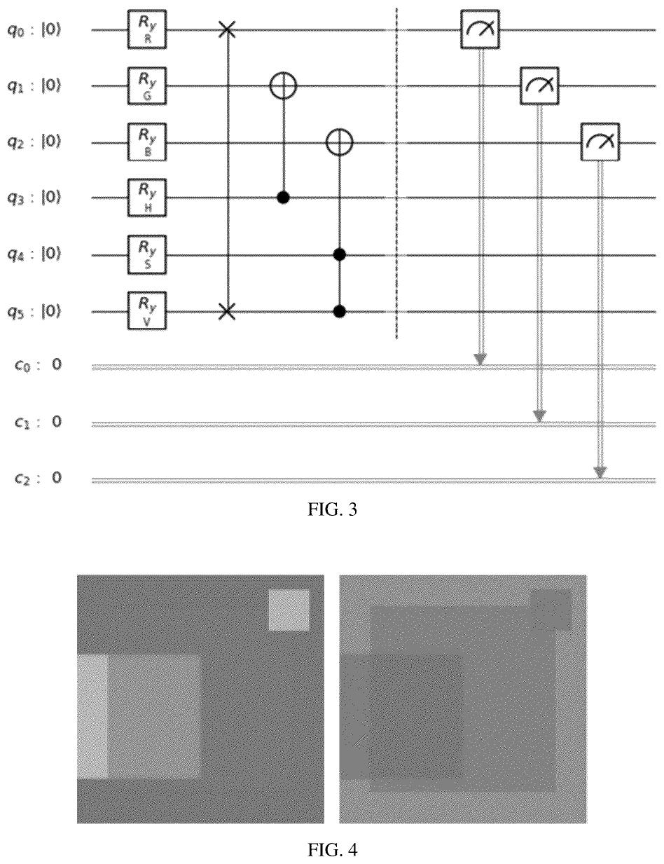

A method of entangling among different channels of a same image to produce a color editing effect is often used in stylized image processing. Such image processing usually refers to modify the intensity of each channel of the image and a relationship among the channels to change the color rendering effect of the image, forming a particular image style feature. Quantum image processing sometimes involves channel transformation in different color modes, hoping to obtain a freer operation space. The editing operation of FIG. 3 is to represent the channel values of an image in the RGB and HSV color modes by qubits, then flip the V channel and the R channel to enhance the contrast effect of the R channel, and entangle the H channel and the G channel to control the value of the G channel and entangle the S channel and the V channel to control the performance of the B channel.

The qubit entanglement operation for mixed colors of different images is as follows.

A color relationship operation among different images is often used for artistic style transfer. For example, the color relationship of image A is replaced with that of image B, resulting in color substitution, but the image structure remains unchanged. In quantum computing of image colors, an entanglement relationship among the channels of different images may be controlled to performing editing such as information substitution, flipping and weighting, resulting in effects such as style transfer, comprehensive mixing, and abrupt form change.

Quantum editing operation for graphic image colors driven by data is as follows.

Data or other structural elements may be used as qubit control entanglement information for a color image. The data can be fused into the color image. Not only the color relationship or visual effect of the image may be changed, but also the data may be hidden in the image, playing a role as watermark or in carrying important information. Since such information is often variables introduced from the outside, it may be used as an element for graphic image interaction. Especially when external data is input constantly, a dynamic interaction effect can also be supported.

The editing operation of the pixel position and the image structure is as follows.

There are usually two methods for representing pixel positions of an image: one is to map a pixel to positions in a width axis direction and height axis direction of the image in a Cartesian coordinate, which are represented in the form of (x, y); the other one is to record the pixels of the image in a sequence set line by line, each pixel occupying a fixed position in the sequence. The first method must represent horizontal coordinate and vertical coordinate values of a pixel by two qubits, respectively. The second method uses only one qubit to represent the position of the occupied pixel. Although each pixel has an index, but a pixel line breaking rule cannot be determined, the position of the pixel can be restored only by means of the display size of the image.

Due to the problem of noise of quantum computing, when the position of each pixel is recalculated, pixel displacement will always occur, resulting in that partial image region cannot be covered. This case is directly proportional to an image size and inversely proportional to the number of measurements. When low-accuracy statistical data corresponds to a highly accurate position parameter, the influence of the noise is relatively obvious. This may not be a serious problem for small values. For example, in the value range from 0 to 255 of a color channel, the influence of noise is not significant. However, since values representing a sequence of pixels in large-size graphics are large, the jittering of the positions of the pixels is obvious when new graphics are generated after the quantum computing. When the positions of the pixels are represented by a single-dimensional pixel sequence, the influence of the noise is relatively obvious.

### Embodiment 1

Assuming a gray having a single-channel color value being C (0 to 255 representing black to white), the gray is now transformed into a state of a qubit, i.e., a value of included angle θ on the Bloch sphere:

$$\\ θ = acos ( 2 \frac{C}{255} - 1 ) .$$

In a quantum computing program, a qubit is preset, and the value of 0 is assigned to a qubit operation gate Ry (rotated by θ).

By using the above-mentioned method, the information of the digital color may be transferred into the quantum computing program, and further editing operation is performed as needed, or a quantum computing result is directly obtained through quantum measurement.

Since it is measured in a single quantum measurement that the probabilities of the states |0 [symbol] and |1 [symbol] meet |ψ [symbol] =α|0 [symbol] +β|1 [symbol] and α²+β²=1, the binary digital value of the color can be restored as long as the statistical probability (α) of |0 [symbol] is obtained, i.e., α×255.

Following the above-mentioned principle, it can be realized that the digital single-channel color value is transferred into a quantum computer for computing processing, and then a quantum computing result is transformed into the digital color value.

Assuming an RGB three-channel color C (R, G, B) (R, G, and B refer to values of red, green, and blue channels, respectively, each with a threshold range of 0 to 255), three channel values are transformed into states of qubits, and still transformed into the values of included angle θ on the Bloch sphere:

$$\\ θ = acos ( 2 \frac{C}{255} - 1 )$$

(C is replaced with the value of R, G, or B).

In the quantum computing program, a qubit is preset for the three channels, and the value of θ of each channel is assigned to the qubit operation gate Ry (rotated by θ).

By using the above-mentioned method, the channel information of the digital color may be transferred into the quantum computing program, and further editing operation is performed as needed, or a quantum computing result is directly obtained through quantum measurement.

Since it is measured in the measurement of the three-quantum superposition state that the probabilities of the states |0> and |1> meet:

$$\\ \vert ψ 〉 = {P}_{1} \vert {R}_{0} {G}_{0} {B}_{0} > + {P}_{2} \vert {R}_{0} {G}_{0} {B}_{1} > + {P}_{3} \vert {R}_{0} {G}_{1} {B}_{0} > + {P}_{4} \vert {R}_{0} {G}_{1} {B}_{1} > + {P}_{5} \vert {R}_{1} {G}_{0} {B}_{0} > + {P}_{6} \vert {R}_{1} {G}_{0} {B}_{1} > + {P}_{7} \vert {R}_{1} {G}_{1} {B}_{0} > + {P}_{8} \vert {R}_{1} {G}_{1} {B}_{1} >$$

(e.g., R₀ represents that the state of the bit of the R channel is |0 [symbol] , and B₁ represents that the state of the bit of the B channel is |1 [symbol] ),

and P₁²+P₂²+P₃²+P₄²+P₅²+P₆²+P₇²+P₈²=1, according to this law, the probability values of the R, G, and B channels being in the state |0 [symbol] are respectively as follows:

$$\\ R = {P}_{\vert 000 >} + {P}_{\vert 001 >} + {P}_{\vert 010 >} + {P}_{\vert 011 >} , i . e . , {P}_{1} + {P}_{2} + {P}_{3} + {P}_{4} ;$$

$$\\ G = {P}_{\vert 000 >} + {P}_{\vert 100 >} + {P}_{\vert 001 >} + {P}_{\vert 101 >} , i . e . , {P}_{1} + {P}_{2} + {P}_{5} + {P}_{6} ; and$$

$$\\ B = {P}_{\vert 000 >} + {P}_{\vert 110 >} + {P}_{\vert 100 >} + {P}_{\vert 010 >} , i . e . , {P}_{1} + {P}_{3} + {P}_{5} + {P}_{7} .$$

The probability value of each channel is then multiplied by 255 to obtain the binary color channel value of the channel.

Following the above-mentioned principle, it can be realized that the digital RGB three-channel color values are transferred into the quantum computer for computing processing, and then quantum computing results are transformed into the digital color values. If the maximums of the channel thresholds of other multi-channel colors are not 255 (e.g., H in HSV is 0 to 360), 255 in the transformation formula is replaced by the maximums.

Since each image is a two-dimensional array composed of pixels, and each pixel has a specific coordinate (x, y), if a width and a height of the image are each measured by the number of pixels, they are denoted by X and Y, respectively.

Taking an image having a width of 400 (X=400) and a height of 300 (Y=300) for example, the position (x, y) of any pixel therein may be mapped and transformed into a two-qubit superposition state (|xy>) by using

$$\\ {θ}_{x} = acos ( 2 \frac{x}{400} - 1 )$$

and

$$\\ {θ}_{y} = acos ( 2 \frac{y}{300} - 1 ) .$$

By using the above-mentioned method, the position coordinate information of any pixel in the image may be transferred into the quantum computing program, and further editing operation is performed as needed, or a quantum computing result is directly obtained through quantum measurement.

Since it is measured in the measurement of the two-quantum superposition state that the probabilities of the states |0> and |1> meet:
   |ψ>=P₁|x₀y₀>+P₂|x₀y₁>+P₃|x₁y₀>+P₄|x₁y₁>, and P₁²+P₂²+P₃²+P₄²=1, the probability values of the two variables of the pixel coordinates being in the state |0) are respectively as follows:

$$\\ x = {P}_{1} + {P}_{2} ;$$

and

$$\\ y = {P}_{1} + {P}_{3} .$$

Then, x and y are multiplied by the width and the height of the image (x*400, y*300) to restore the coordinate position of the pixel.

By using the pixel position representation method, if the states of x and y are edited in the quantum computing program, the structure of image may be changed.

By using the methods of the foregoing three parts in combination, all pixels in a color image along with color channel information may be represented as a qubit superposition combination by means of a cyclic matrix:

$$\\ \vert RGB > ⊗ \vert {xy}_{} > .$$

That is, the color information of each pixel is represented by the superposition of three qubits, and the position information of each pixel is represented by the superposition of two qubits. Thus, the colors and the image structure can be processed and computed in the quantum computer.

Embodiment 2: quantum image processing sometimes involves channel transformation in different color modes, hoping to obtain a freer operation space. The editing operation of FIG. 1 includes representing the channel values of an image in the RGB and HSV color modes by qubits, then flipping the V channel and the R channel to enhance the contrast effect of the R channel, and entangling the H channel and the G channel to control the value of the G channel and entangling the S channel and the V channel to control the performance of the B channel. A specific implementation sequence of the quantum computing program is as follows.
1. A pixel (0, 0) of an image is extracted in a classical computing environment, and RGB color channel values (R, G, B) and HSV color channel values (H, S, V) of the pixel are acquired.
2. Each channel value of the pixel is converted into a corresponding qubit Bloch angle by using a conversion formula

$$\\ θ = acos ( 2 \frac{i}{max} - 1 ) .$$

In the conversion formula, i represents a channel value; when a value of R, G, or B is converted, a value of max is 255; when a value of H is converted, the value of max is 360; and when a value of S or V is converted, the value of max is 100.
3. Six qubits are created in a quantum computer and each assigned with an Ry gate, and rotation angles thereof are set as qubit Bloch angles corresponding to the six color channels, respectively.
4. Qubit states of the R channel and the V channel are flipped by using a SWAP gate. The qubit of the H channel is allowed to control the qubit of the G channel by means of a CNOT gate. When the state of H is |1>, the state of G is flipped (|1> to |0>, or |0> to |1>). The qubits of the S channel and the V channel are allowed to control the qubit of the B channel by means of a CCNOT gate, and when the states of S and V are |1> simultaneously, the state of B is flipped (|1> to |0>, or |0> to |1>).
5. Quantum measurement is performed on three qubits of R, G, and B to obtain a measurement result of qubit superposition |RGB>:

$$\\ ψ 〉 = {P}_{1} \vert {R}_{0} {G}_{0} {B}_{0} > + {P}_{2} \vert {R}_{0} {G}_{0} {B}_{1} > + {P}_{3} \vert {R}_{0} {G}_{1} {B}_{0} > + {P}_{4} \vert {R}_{0} {G}_{1} {B}_{1} > + {P}_{5} \vert {R}_{1} {G}_{0} {B}_{0} > + {P}_{6} \vert {R}_{1} {G}_{0} {B}_{1} > + {P}_{7} \vert {R}_{1} {G}_{1} {B}_{0} > + {P}_{8} \vert {R}_{1} {G}_{1} {B}_{1} > .$$

6. New R, G, and B channel values are calculated:

$$\\ R = ( {P}_{1} + {P}_{2} + {P}_{3} + {P}_{4} ) * 255 ; G = ( {P}_{1} + {P}_{2} + {P}_{5} + {P}_{6} ) * 255 ; and$$

$$\\ B = ( {P}_{1} + {P}_{3} + {P}_{5} + {P}_{7} ) * 255.$$

7. Returning to a classical computing program, the pixel is replaced and updated with the new R, G, and B channel values.
8. A cycle program is utilized to perform the operations of steps 1 to 7 on the remaining pixels repeatedly until editing of the whole image is completed. FIG. 4 are pictures showing an original color image (left) and a result after executing the quantum computing program (right).

In step 4 of the above operation steps, combination operation of a plurality of quantum gate operations can be realized according to a specific quantum algorithm program. Moreover, qubit information (q₃, q₄, q₅) implementing control may be from other images, colors, pixels, or information in other forms to support more complicated and richer editing algorithms.

It should be noted that the foregoing are merely descriptions of optional embodiments of the present disclosure and the employed technical principles. Those skilled in the art will understand that the present disclosure is not limited to the specific embodiments described herein, and various obvious changes, adjustments and replacements can be made by those skilled in the art without departing from the protection scope of the present disclosure. Therefore, although the present disclosure has been described in detail through the above embodiments, the present disclosure is not limited to the above embodiments, and may also include more other equivalent embodiments without departing from the concept of the present disclosure, and the scope of the present disclosure is determined by the scope of the appended claims.

What is claimed is:

1. A quantum representation and computation method of a color, comprising:
step 1, converting a digital color into quantum bit (qubit) information according to channel values, which comprises converting element values of the digital color into a qubit superposition state representation;
step 2, performing an editing operation by a quantum computing program, which comprises a computation method of editing a qubit state of the color through using a quantum operation gate; and
step 3, restoring the digital color, which comprises converting a quantum editing result of the color into displayable color information, and applying the displayable color information to a qubit representation and editing of a color graphic image.

2. The method according to claim 1, wherein representing a color parameter of a single channel by a qubit in step 1 comprises: mapping each color channel value ranging from 0 to 255 into a value of an angle θ of a qubit Bloch sphere ranging from 0 to π:
$$\\ θ = acos ( 2 \frac{i}{max} - 1 ) ;$$
rotating θ to a corresponding angle by a quantum gate, performing further quantum operation computing, and setting a probability value α for a state |0> or β for a state |1> as a mapped value or a computing result for the channel;
wherein an Ry gate is utilized to set a bit state of the color parameter; the quantum gate is operated to perform edition by rotating a point represented by a position on the Bloch sphere about a coordinate axis of the Bloch sphere to change the qubit superposition state; when the color parameter is represented by a qubit, a color element is converted into a corresponding angle θ, and a default initial superposition state |0> is rotated by θ about a Y-axis and an X-axis through using an R gate, thereby obtaining a quantum representation value of the color; the quantum superposition state is measured along a z-axis to obtain the probability value α which reflects an essential feature of the color; and if the color needs to be edited, after it is indicated that the channel value is converted to the Ry gate, a quantum state is edited under a control of the quantum gate until a measurement result is obtained.

3. The method according to claim 1, wherein a relationship between qubit states corresponding to three channels of the color in step 1 and probabilities is represented as:
$$\\ \vert ψ > = {P}_{1} \vert {R}_{0} {G}_{0} {B}_{0} > + {P}_{2} \vert {R}_{0} {G}_{0} {B}_{1} > + {P}_{3} \vert {R}_{0} {G}_{1} {B}_{0} > + {P}_{4} \vert {R}_{0} {G}_{1} {B}_{1} > + {P}_{5} \vert {R}_{1} {G}_{0} {B}_{0} > + {P}_{6} \vert {R}_{1} {G}_{0} {B}_{1} > + {P}_{7} \vert {R}_{1} {G}_{1} {B}_{0} > + {P}_{8} \vert {R}_{1} {G}_{1} {B}_{1} > ;$$
wherein probabilities of states meet:
$$\\ {P}_{1}^{{}_{} 2} + {P}_{2}^{{}_{} 2} > + {P}_{3}^{{}_{} 2} > + {P}_{4}^{{}_{} 2} > + {P}_{5}^{{}_{} 2} > + {P}_{6}^{{}_{} 2} > + {P}_{7}^{{}_{} 2} > + {P}_{8}^{{}_{} 2} = 1 ;$$
that is, an overall sum of probabilities that a value of a red (R) channel is 0 based on a corresponding measurement result term thereof is:
$$\\ R = {P}_{1} + {P}_{2} + {P}_{3} + {P}_{4} ;$$
therefore, when measured by a color editing program resulting from superposition of three qubits, a sum of probabilities that a qubit corresponding to each channel is in a state |0> is regarded as a measured value for the channel; and a sum of P values for each channel is:
R=P_{|000>}+P_{|001>}+P_{|010>}+P_{|011>} (a sum of probabilities that a qubit corresponding to the R channel is in the state |0>);
G=P_{|000>}+P_{|100>}+P_{|001>}+P_{|101>} (a sum of probabilities that a qubit corresponding to a G channel is in the state |0>); and
B=P_{|000>}+P_{|110>}+P_{|100>}+P_{|010>} (a sum of probabilities that a qubit corresponding to a B channel is in the state |0>).

4. The method according to claim 1, wherein for a bit representation of a color relationship between a plurality of colors in step 1, the plurality of colors need to meet following condition:
$$\\ \{ {R}_{1} , {G}_{1} , {B}_{1} \} \neq \{ {R}_{2} , {G}_{2} , {B}_{2} \} \neq ... \neq \{ {R}_{n} , {G}_{n} , {B}_{n} \} ,$$
according to the condition, on the Bloch sphere, positions each representing ψ of a color do not overlap; and
for description of a constitution relationship of two colors, a spatial relationship of the two colors on the Bloch sphere is described by a Euclidean metric formula:
$$\\ ρ = \sqrt{} ( {( {R}_{1} - {R}_{2} )}^{2} + {( {G}_{1} - {G}_{2} )}^{2} + {( {B}_{1} - {B}_{2} )}^{2} ) .$$
